(19) United States
(12) Patent Application Publication
(10) Pub. No.: US 2005/0132334 A1
(43) Pub. Date: Jun. 16, 2005

(54) Computer-implemented systems and methods for requirements detection

(76) Inventor: John David Busfield, Valencia, CA (US)

Correspondence Address: STEPHEN D. SCANLON, JONES DAY, 901 LAKESIDE AVENUE, CLEVELAND, OH, 44114, US

(21) Appl. No.: 10/989,113

(22) Filed: Nov. 15, 2004

Related U.S. Application Data
(60) Provisional application No. 60/520,195, filed on Nov. 14, 2003.

(51) Int. Cl. G06F 9/44

(52) U.S. Cl. 717/124

(57) ABSTRACT

Computer-implemented systems and methods that detect requirements. Rules-based requirements specify requirements for an application to operate properly upon a computer system. A requirements detection engine receives the rules-based requirements and determines whether a computer system can operate the application based upon the received rules-based requirements.

### CROSS-REFERENCE TO RELATED APPLICATION

This application claims priority to and the benefit of U.S. Provisional Application Ser. No. 60/520,195 filed on Nov. 14, 2003, of which the entire disclosure (including any and all figures) is incorporated herein by reference.

### TECHNICAL FIELD

This document relates generally to handling computer-related and/or software related requirements and more particularly to detection of computer-related and/or software related requirements.

### BACKGROUND

With the large variety of computer platforms, operating systems, browsers, browser features and third party plugins, it is a challenge for software designers to design applications that can operate on all or a wide variety of systems with all or most possible feature combinations. Many times the application designer will have to specify that the application can only run on certain systems with the appropriate feature combinations. All others are to be excluded. To this end, ‘sniffer’ systems have been developed that test an end-users system and allow the application to be invoked only when the test passes. However, such systems typically must have their own custom-made ‘sniffer’ test.

### SUMMARY

In accordance with the teachings provided herein, systems and methods for operation upon data processing devices are provided in order to overcome one or more of the aforementioned disadvantages or other disadvantages concerning requirements detection.

As an example of a system and method, a data store contains rules-based requirements that specify requirements for an application to operate properly upon a computer system. A requirements detection engine receives the rules-based requirements and determines whether a computer system can operate the application based upon the received rules-based requirements.

As another example, a system and method may be configured as a single, multi-purpose detection engine that could be passed a rules based definition file to detect compatibility requirements.

As will be appreciated, the systems and methods disclosed herein are capable of other and different embodiments, and capable of modifications in various respects. Accordingly, the drawings and description set forth herein are to be regarded as illustrative in nature and not restrictive.

### BRIEF DESCRIPTION OF THE DRAWINGS

FIG. 1 is a flow diagram depicting software and computer components utilized in detecting requirements.

FIG. 2 is block diagram depicting a requirements engine interacting with applications and operating systems.

FIG. 3 is an interface screen shot illustrating an example of an interface box displaying results of a compatibility test.

FIG. 4 provides an example client application.

FIGS. 5A-5C provide an example of rule definitions.

### DETAILED DESCRIPTION

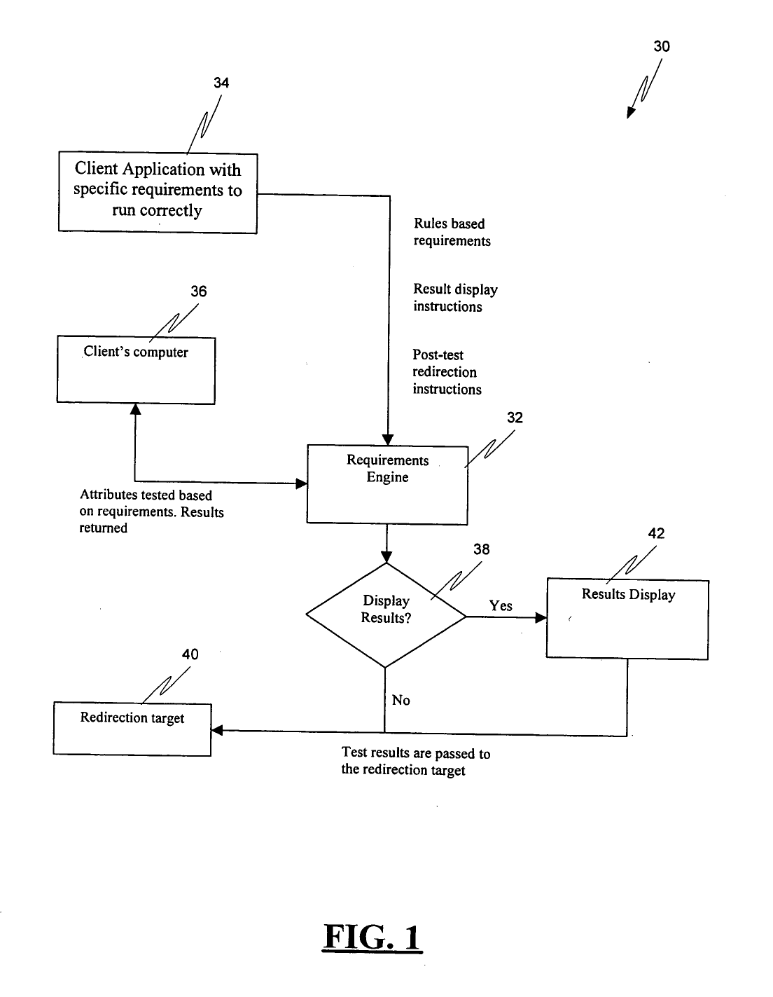

FIG. 1 depicts a computer-implemented system 30 that detects requirements by interpreting rules contained in a definition data store. A requirements detection engine 32 receives rules-based requirements that specify requirements for a client application 34 to operate properly upon a computer system 36. In other words, a requirements detection engine helps analyze whether one or more different client computers can operate an application given the application's requirements. Other information may be provided to a requirements detection engine, including: whether and how to display requirements testing results to a user; and post-test redirection instructions (e.g., instructions to redirect to an error handling application after the test is performed).

The requirements detection engine 32 causes the client computer's attributes to be tested in order to determine whether the application 34 can operate upon a tested computer 36. The attributes are tested based upon the requirements, and the results are returned to the requirements detection engine 32.

As examined at decision block 38, if the result display instructions provided to the requirements detection engine 32 indicate that the results are not to be displayed, then based upon the post-test redirection instructions, the test results are passed to the redirection target 40. However, if the result display instructions indicate that the results are to be displayed, then before the test results are passed to the redirection target 40, the user is shown a display 42 of the results.

In such a system 30, a requirements detection engine can determine pass/fail status, optionally display pass/fail results, and redirect to an error handling application, the original calling application or some other application. Applications are no longer be required to implement custom detection code. Requirements rules are located externally to the requirements detection engine, and multiple requirements detection engines can also access data stored in the rules-based requirements data store.

A requirements detection engine may be used for web based applications and other type applications, such as non-web based environments. It should also be understood that similar to the other processing flows described herein, the steps and the order of the steps in FIG. 1 may be altered, modified and/or augmented and still achieve the desired outcome.

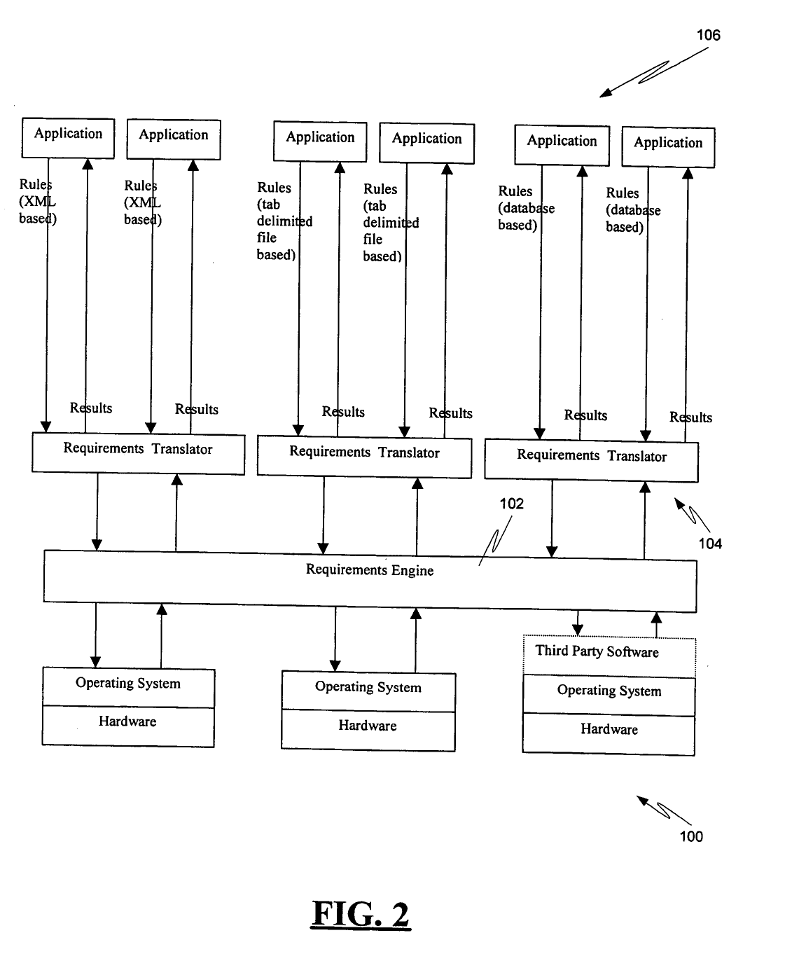

FIG. 2 provides another example of how communication can occur between various parts of a requirements detection system. At the lowest level 100 are the various operating systems and hardware platforms. The operating systems expose various methods for querying the hardware capabilities and provide access to their own abilities. Things like screen resolution, installed software components, etc. can be found by making the proper requests to the operating system.

Additionally there may be third party software running on top of the operating system that can provide additional capabilities. One example of third party software would be a web browser. The requirements engine layer 102 may be built on top of the operating system or third party software layer. Its purpose is to expose an API of functions that can be queried for the existence of a feature and to communicate with the third party software or operating system layer to determine the status of a feature. The requirements engine can be implemented in any way a program can be written. Some examples include but are not limited to compiled executable, .NET service, Java applet, JSP servlet or JavaScript code.

A layer above the requirements engine 102 could be a requirements translator 104. Its purpose is to understand the requirements engine API so that the various exposed methods can be queried for information and be able to translate a set of rules that may be sent to it by an application.

As shown in FIG. 2, there are many ways that requirements rules can be implemented. Some examples include, but are not limited to XML, delimited flat file and databases. For each of the ways in which rules may be implemented, there is a translator in this example that can understand the rules and convert them into API calls that the requirements engine understands.

At the highest level, applications 106 send a set of rules to a requirements translator, and receive back the results in a format consistent among all translators 104.

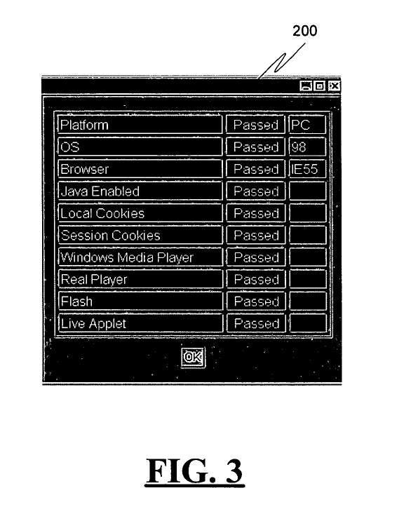

FIG. 3 is an interface screen shot illustrating an example of an interface box 200 displaying results of a compatibility test. With reference to FIG. 3, example test results include whether the computer was compatible with respect to a number of application requirements, such as platform requirements, operating system requirements, browser requirements, etc. In this example, the tested computer passed the requirements shown in FIG. 3.

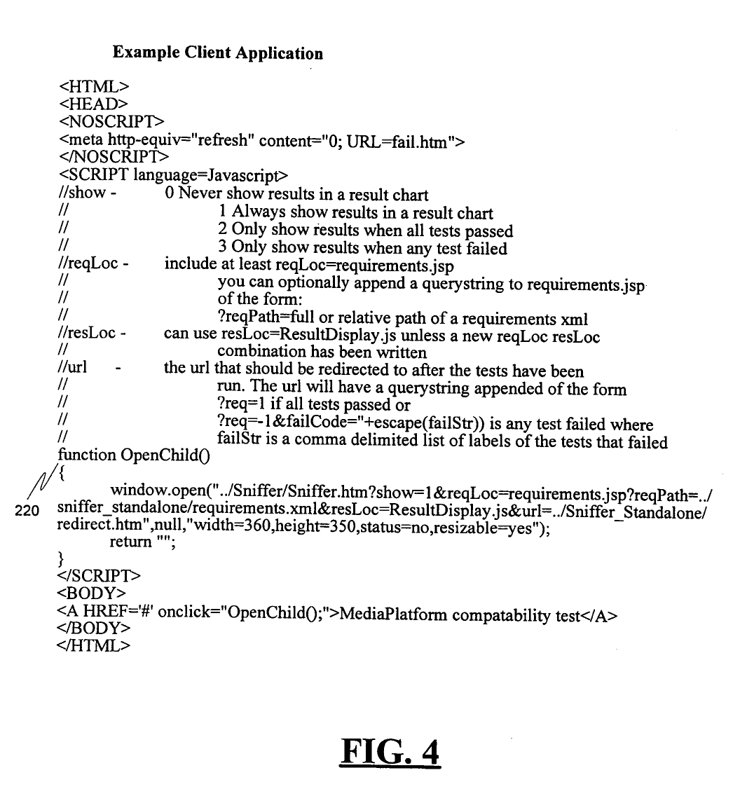

As another illustration, FIG. 4 displays an example of a client application that needs testing. With reference to FIG. 4, the OpenChild( ) function 220 invokes the call to a requirements engine. The requirements engine in this case is sniffer.htm. It takes the show, reqLoc, resLoc and url parameters. The ‘show’ parameter determines if and how the engine itself will show results. The ‘reqLoc’ parameter specifies where the engine can find the rules for how the engine should proceed with testing. The ‘resLoc’ parameter specifies where the engine can find the format for the result display. The ‘url’ parameter specifies where the engine should redirect upon completion, passing the test results.

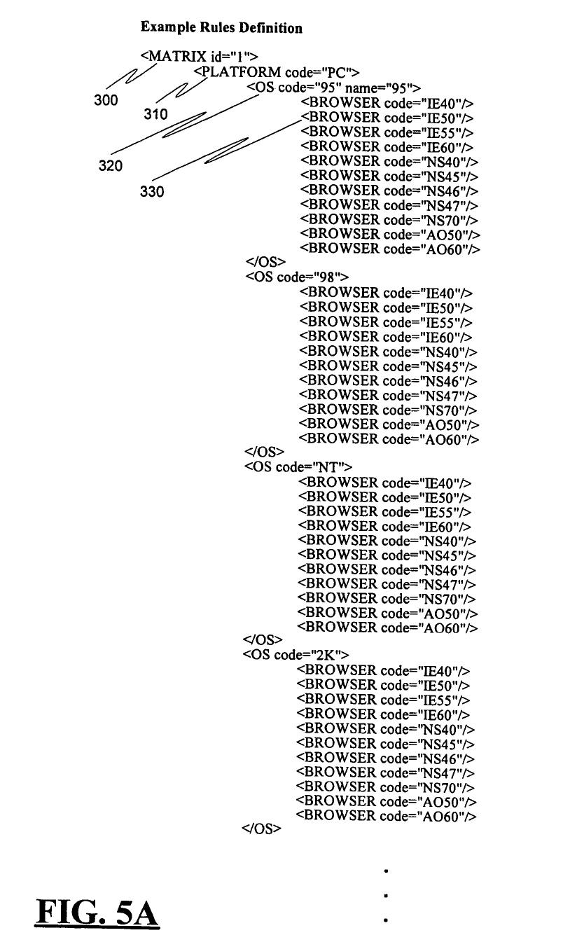

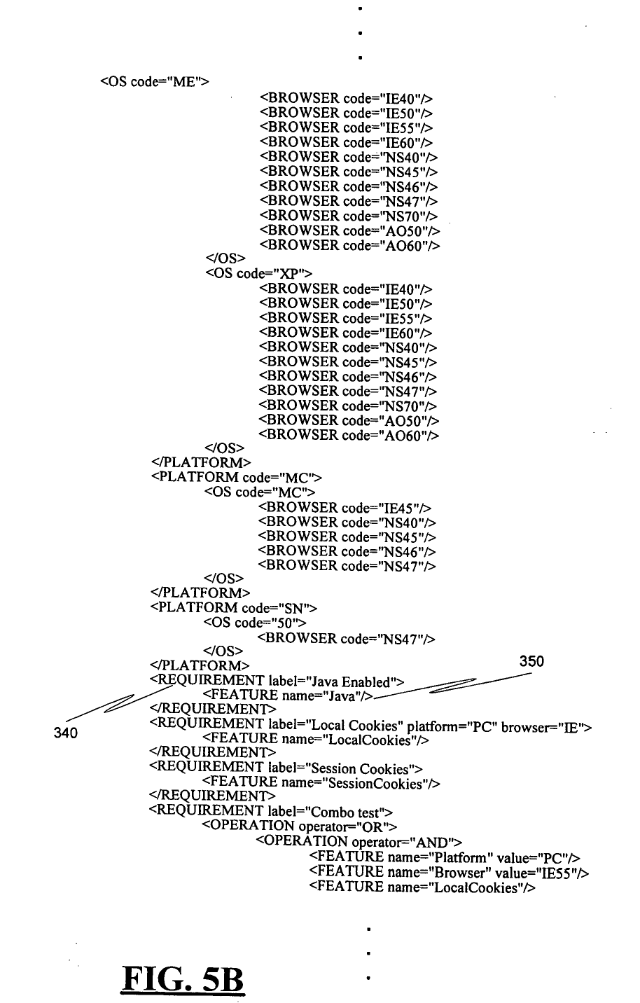

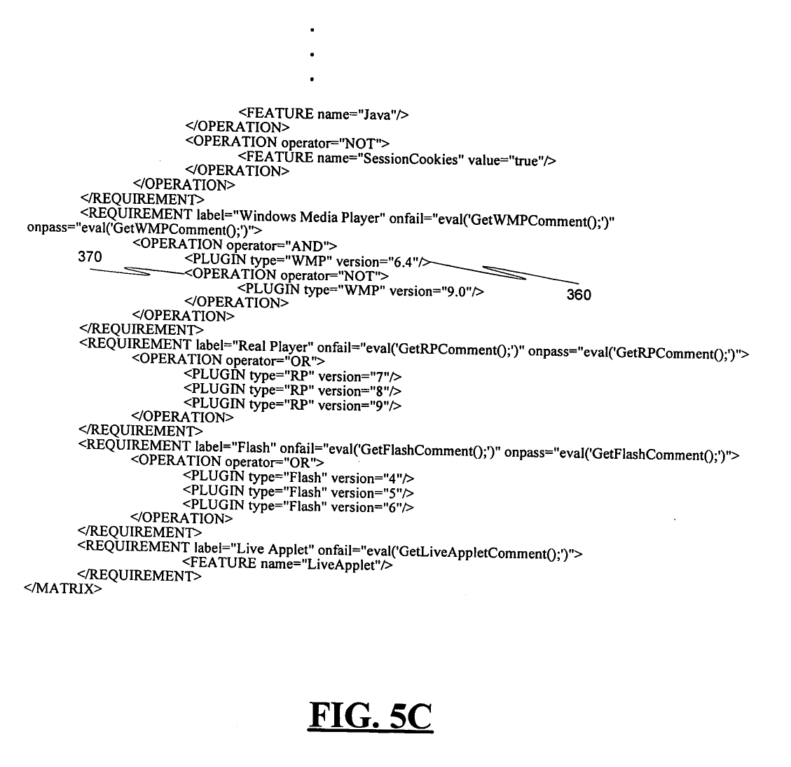

FIGS. 5A to 5C depict example rules definitions that a requirements engine can use in handling applications, such as the example client application of FIG. 4. In the xml example of FIGS. 5A to 5C, the MATRIX xml definition is a way to define requirements for support of web applications. By defining support requirements in an xml document, changes and updates can easily be made without the need to reprogram the detection code. The following describe elements used in the example rules definition:
MATRIX (an example is shown at 300)—the document element.
   id: optional in this example:
PLATFORM (an example is shown at 310)—defines a supported platform. A PLATFORM does not have to be supplied. If it is not supplied then the basic tests, platform/os/browser, may not be shown but any other requirements tests will still be performed.
   code: PC—a PC type platform
   MC—an Apple Computers type platform
   SN—a Sun type platform
OS (an example is shown at 320)—a supported operating system
   code: 95—Windows 95
      98—Windows 98
      NT—Windows NT
      2K—Windows 2000
      ME—Windows ME
      XP—Windows XP
      MC—All Macintosh Operating systems
      40—Sun OS 4.0
      50—Sun OS 5.0
   name: optional in this example, a human readable name for the operating system
BROWSER (an example is shown at 330)—a supported browser and version
   code: IE40—Internet Explorer 4.0
      IE45—Internet Explorer 4.5 (Mac only)
      IE50—Internet Explorer 5.0
      IE55—Internet Explorer 5.5
      IE60—Internet Explorer 6.0
      NS40—Netscape 4.0
      NS45—Netscape 4.5
      NS46—Netscape 4.6
      NS47—Netscape 4.7
      NS60—Netscape 6.0
      AO50—AOL 5.0
      AO60—AOL 6.0
REQUIREMENT (an example is shown at 340)—additional requirements beyond the platform-os-browser check. A requirement tag will add another row to the list of checks performed.
   label: The human readable label that will appear to tell the viewer what has been checked.
   platform: optional in this example. If provided, this requirement check will only be performed on the indicated platform. Platform codes are the same as defined in the PLATFORM tag above.
   browser: optional in this example. If provided, this requirement check will only be performed on the indicated browser. Browser codes are the same as defined in the BROWSER tag above. They may also be a shortened version of the above browser tags. For example, if only Internet Explorer browsers should be checked, and all Internet Explorer browsers should be checked, use browser=“IE”. If Internet Explorer 5.0 and 5.5 should be checked, use browser=“IE5”.
   onpass: optional in this example. If provided, this is the message that will appear as a comment for this requirement check. For example, if, when this check passes, you want the comment to display “Great!”, use onpass=“Great!”. Predefined functions that return a string may also be called. For example a predefined function GetBrowser( ) can be used which returns the browser/version string. To have that appear in the comments section use the format onpass=“eval(‘GetBrowser( )’)”. The following is an example list of predefined functions that return a string: GetBrowser( ); GetOS( ); GetPlatform( ); GetLiveAppletComment( ); GetWMPComment( ); GetRPComment( ); GetFlashComment( ); GetLiveAppletComment( ).
   onfail; optional in this example. Same as onpass above but used when a requirement check fails.
FEATURE (an example is shown at 350)—a feature of the browser that can be checked
   name: the name of the feature to be tested. Possible values include:
      Java—if Java is enabled on the browser.
      LocalCookies—if storing of cookies on the user?s machine is allowed on the browser. Local Cookies is an Internet Explorer specific test and will always return ‘failed’ on Netscape. To prevent the ‘failed’ check from showing in Netscape use the browser=“IE” attribute on the REQUIREMENT tag.
      SessionCookies—to perform this test a cookie is actually written and then read to see if the cookie was properly stored.
      Platform—the platform. Acceptable values are the same as for the PLATFORM tag above.
      OS—the operating system. Acceptable values are the same as for the OS tag above.
      Browser—the browser. Acceptable values are the same as for the BROWSER tag above. In addition, shortened versions may be used. (See the browser attribute under the REQUIREMENT tag above).
      LiveApplet—tests to see if the live applet is functioning. A message is sent to and received from a live server to test this feature.
   value: the value that this feature should match. If not supplied the value is assumed to be ‘true’. For features such as Java, LocalCookies, SessionCookies and LiveApplet a value of true or false is expected. For feature such a Platform, OS and Browser, the value attribute should always be supplied because these items expects string values such as “PC” or “IE55”.
PLUGIN (an example is shown at 360)—a plugin to the browser such as an ActiveX control
   type: the type of plugin. Acceptable values are
      WMP—Windows Media Player
      RP—Real Player
      Flash—Real Player
   version: optional in this example. If not supplied then a check for any version of the plugin will be performed. Current version for WMP are 6.4, 7.0, 8.0 and 9.0. Current versions for RP are G2,7.0,7.1,8.0,8.1,8.2,9.0. Current versions for Flash are 2,3,4,5,6.
OPERATION (an example is shown at 370)—Using the OPERATION tag, complex logic can be implemented. Checks for multiple features and plugins can be ANDed or ORed together and features can be excluded by wrapping a feature in a NOT operation. Only a single feature or plugin can be included within a NOT operation but many features and plugins can be included within an AND or OR operation
   operator: AND
      OR
      NOT
         While examples have been used to disclose the invention, including the best mode, and also to enable any person skilled in the art to make and use the invention, the patentable scope of the invention is defined by claims, and may include other examples that occur to those skilled in the art. For example, the rules listed in FIGS. 5A-5C are illustrative in nature and may be altered to suit the application at hand. There are also many different ways to implement both the rules and the requirements engine including, but not limited to, XML, tab delimited files, Compiled .exe, .net service, and Java applet servlet.

It is further noted that the systems and methods may include data signals conveyed via networks (e.g., local area network, wide area network, internet, etc.), fiber optic medium, carrier waves, wireless networks, etc. for communication with one or more data processing devices. The data signals can carry any or all of the data disclosed herein that is provided to or from a device. For example, a data signal may be conveyed over a network from a requirements engine to a computer that is to be tested. As another example, a data signal may be conveyed over a network from a client application to a requirements engine.

User interface screens can be web pages accessible over a network such as over the world-wide web (web). The web is a method of accessing information on the Internet which allows a user to navigate the Internet resources intuitively, without IP addresses or other technical knowledge. A user's computer can contain client software, known as a web “browser,” which is used to display web pages as well as traditional non-web files on the client system.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The systems' and methods' data (e.g., associations, mappings, etc.) may be stored and implemented in one or more different types of computer-implemented ways, such as different types of storage devices and programming constructs (e.g., data stores, RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context clearly dictates otherwise; the phrase “exclusive or” may be used to indicate situation where only the disjunctive meaning may apply.

1. A computer-implemented system that detects requirements, comprising:
a data store that contains rules-based requirements;
wherein the rules-based requirements specify requirements for a client application to operate properly upon a computer system;
a requirements detection engine that receives the rules-based requirements;
wherein the requirements detection engine determines whether a computer can operate the client application based upon the received rules-based requirements.

2. The system of claim 1, wherein the data store is in an XML format and provided to the requirements detection engine; wherein the data store is located externally to the requirements detection engine.

3. The system of claim 2, wherein multiple requirements detection engines can access data stored in the rules-based requirements data store.

4. A data signal that is transmitted using a network, wherein the data signal includes data about the rules-based requirements of claim 1; wherein the data signal comprises packetized data that is transmitted through a network.

5. The system of claim 1, wherein the requirements engine receives other information, including whether and how to display requirements testing results to a user, and post-test redirection instructions.
